(19) United States
(12) Patent Application Publication
(10) Pub. No.: US 2004/0139647 A1
(43) Pub. Date: Jul. 22, 2004

(54) Fishing apparatus

(76) Inventor: David Esberger, Lincoln (GB)

Correspondence Address: WATOV & KIPNES, P.C., P.O. BOX 247, PRINCETON JUNCTION, NJ, 08550, US

(21) Appl. No.: 10/755,167

(22) Filed: Jan. 9, 2004

(30) Foreign Application Priority Data
Jan. 16, 2003 (GB) 0300944.6

(51) Int. Cl. A01K 91/02

(52) U.S. Cl. 43/19

(57) ABSTRACT

Fishing apparatus comprises a weight comprising attachment means for attaching the weight to a fishing line and means for projecting the weight into a body of water. The means for projecting comprises a barrel having a bore, the bore being adapted to receive the weight, a tank adapted to hold a reservoir of compressed gas, such as air, and valve means connected between the bore and tank, and operable to supply compressed gas from the tank to the bore to project the weight out of the barrel.

### FIELD OF THE INVENTION

The present invention relates to fishing apparatus, and in particular, although not exclusively, to apparatus for beach casting.

### BACKGROUND TO THE INVENTION

When sea angling from a beach a fishing weight attached to a fishing line and one or more hooks is typically cast out into the sea using a rod. In many cases significant numbers of fish are to be found only at considerable distances from the water's edge. For example, on a tidal coastline large numbers of fish may be found at distances in excess of 100 metres from the water's edge. As the tide rises up a beach, the fish follow the tide in, but remain in the relatively deep water some distance behind the advancing edge of the water. Clearly, if one can only cast out a fishing line a short distance then it may not be possible to access these large numbers of fish. Thus, there has been significant effort to improve rod design to enable fishing weights to be cast (i.e. projected) farther. State of the art rods enable casting distances up to around 100 metres to be achieved. The very best rods tend to offer only slight improvements on this distance, i.e. improvements in the region of 10%, and yet still command a very high price.

There remains the need for further increases in casting distance.

### SUMMARY OF THE INVENTION

Embodiments of the invention enable casting distances to be achieved which are far in excess of those achievable with rod-casting techniques.

According to a first aspect of the present invention there is provided fishing apparatus comprising a weight comprising attachment means for attaching the weight to a fishing line; and means for projecting the weight into a body of water, characterised in that the means for projecting comprises a barrel having a bore, the bore being adapted to receive the weight; a tank adapted to hold a reservoir of compressed gas, such as air; and valve means connected between the bore and tank, and operable to supply compressed gas from the tank to the bore to project the weight out of the barrel.

Thus, the present invention employs a fundamentally different technique to project the fishing weight into the body of water, compared with traditional rod-casting. With suitable tank pressures and simple manually operated valve means, the weight may be projected, with fishing line attached, distances of around 200 metres. This is almost double the maximum casting distance achievable with rods. In order to increase the casting distance yet further, more sophisticated triggered valves may be used, to rapidly expose the weight in the bore to the gas at pressure. With such refinements, the casting apparatus embodying the invention can project the weight 300 metres and more out to sea. At such distances, there will typically always be plentiful quantities of fish, regardless of the state of the tide.

Advantageously, the weight may be elongate, having a longitudinal axis which is aligned parallel to the axis of the bore when the weight is received in the bore. More preferably, the weight is generally cylindrical. The weight may be a clearance fit in the bore.

In one preferred form, the weight comprises a tube filled with dense material. The tube may be a copper tube, and the filling material may conveniently be lead.

In another preferred embodiment of the invention, the weight is spherical, and suitably has a metal core, for example of lead, with a polymeric coating, which serves to ensure a pressure-tight seal in the barrel and to enhance sliding of the weight in the barrel.

The attachment means may be provided at one end of the weight, and may comprise an eye to which the fishing line may be tied. Alternatively, the weight may have a length of flexible line already attached to it, and the fishing line may be connected to this flexible line.

Preferably, the tank is elongate having an outlet at one end, this outlet being in line with the valve and the barrel. The tank may be cylindrical.

Preferably, the tank is mounted on a base plate, which may be integral, the base plate closing a lower end of the tank.

The tank may be mounted on the base plate such that when the base plate is substantially horizontal the tank is inclined at an angle of approximately 45° to the horizontal. With the barrel in line with the tank, this angle results in the weight being projected the maximum distance for a given gas pressure in the tank.

Conveniently, the apparatus may further include a line attached to the weight, and an anchor slidably mounted on the line. After the line has been cast, pulled by the projected weight, the line may thus be pulled through the anchor until the weight is in contact with the anchor. The anchor then enables the weight to be held at a relatively fixed position on the seabed. Without the anchor, there is the risk that the weight can be dragged along the seabed, preventing the fishing-line from being pulled taut.

Typically, the tank comprises an inlet attached to an inlet valve, through which compressed gas is supplied to the tank. The inlet valve may be a non-return valve.

The apparatus may further comprise a hose connected to the inlet valve and adapted for connection to a compressed-gas refill tank. Scuba diving tanks are particularly suitable for use with embodiments of the invention. They may hold gas at pressures typically in the range 2500-3500 psi.

Advantageously, the apparatus may comprise a compressed-gas refill tank arranged to replenish the weight-projecting tank after operation of the valve means.

Advantageously, in certain embodiments of the invention, the apparatus further comprises a pump operable to charge the tank with compressed gas. In one preferred form, this pump is a foot operated pump, and thus the apparatus may be manually “recharged” after projecting a weight.

Preferably, the apparatus further comprises a pressure gauge arranged to provide an indication of the pressure of gas inside the tank. In certain preferred embodiments, the pressure gauge is calibrated in terms of the distance the weight is projected for a particular inclination of the barrel and tank gas pressure.

Advantageously, the apparatus may comprise a base adapted to engage a ground surface (such as the surface of the beach) and support, either directly or indirectly, the barrel in an inclined position. The base may comprise a base plate adapted to rest on the ground.

The base may comprise at least one spike, for insertion into the ground to hold the barrel at a particular inclination.

The spike or spikes may extend from a base plate, or alternatively a spike may be arranged to extend directly from the tank itself.

Preferably the base is adapted to support the barrel such that its bore is inclined at 45° to the horizontal.

The barrel may be supported such that its orientation with respect to the base is fixed. Alternatively, the apparatus may comprise means for adjusting the orientation of the barrel with respect to the base to alter its inclination. The base may comprise adjustment means for adjusting the inclination of the barrel bore.

Advantageously, the apparatus may comprise indicator means for indicating an inclination of the barrel bore to the horizontal. In one convenient form, this indicator means may be of the spirit level type, with a bubble.

Conveniently, the indicator means should indicate when the barrel bore is inclined at 45° to the horizontal.

Conveniently, the valve means may comprise a manually operated valve, i.e. a valve which is opened manually. In more sophisticated embodiments, however, the valve may comprise a trigger valve which includes: a sealing member which is held against a valve seat by gas pressure in the tank; a hammer triggerable to separate the sealing member from the valve seat to permit gas flow through the valve; and a trigger mechanism for triggering the hammer.

Advantageously, the valve means may comprise means for operating it remotely. This may be achieved by any convenient link, such as a radio signal, a wire in the case of an electrically operated valve, or a pull-cord.

A second aspect of the present invention provides a fishing weight launcher suitable for use in embodiments of the first aspect.

### BRIEF DESCRIPTION OF THE DRAWINGS

Embodiments of the present invention will now be described with reference to the accompanying drawings, of which:

FIG. 1 is a schematic diagram of fishing apparatus embodying the invention;

FIG. 2 is a view of a fishing weight suitable for use with embodiments of the invention;

FIG. 3 is a schematic representation of the weight, anchor and fishing line of an embodiment, in use;

FIG. 4 is a schematic representation of a further embodiment;

FIG. 5 is a schematic representation of a further, remotely triggered embodiment;

FIG. 6 is a schematic representation of yet another embodiment incorporating a refill tank;

FIG. 7 is a schematic cross section of a trigger valve suitable for use in embodiments of the invention.

### DETAILED DESCRIPTION OF PREFERRED EMBODIMENTS

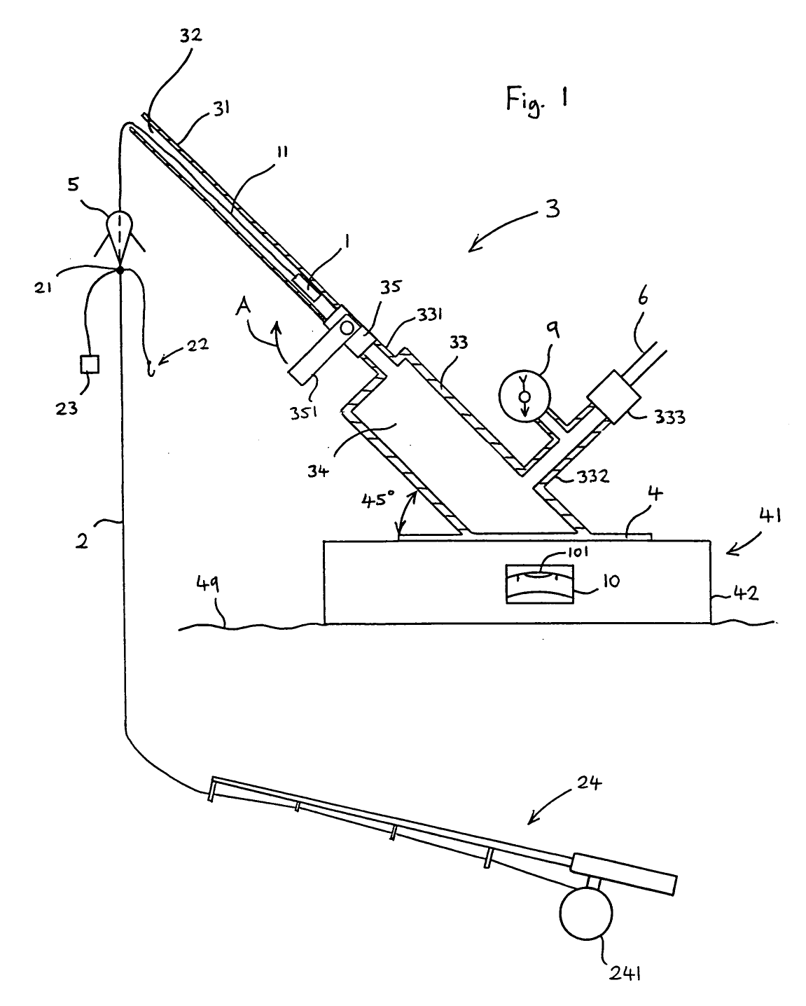

FIG. 1 shows, in schematic form, fishing apparatus embodying the present invention. Selected parts of the apparatus are shown in cross section. The apparatus comprises a weight 1 to which a length of flexible line 11 is attached. The weight 1 is shown received in the bore 32 of a barrel 31. A lower end of the barrel is screwed into a manually operated valve 35, which is in turn screwed onto a threaded outlet 331 of a tank 33 which is able to hold gas at pressure. The tank 33 is generally cylindrical. The outlet 331 is provided at one end of the cylinder, and the opposite, lower end of the cylinder is sealed by a base plate 4. The cylinder and base plate are metal, and are welded together such that the tank and base plate 4 are integral. The base plate 4 makes an angle of 45° to the longitudinal axis of the tank 33. The tank outlet 331, the valve 35 and the barrel 31 are inline (parallel to the longitudinal axis of the tank) such that when the base plate 4 is arranged substantially horizontally, the barrel bore is inclined at 45° to the horizontal to give optimum projection distance of the weight 1. The base plate 4 is attached to a base block 42 formed of suitably dense material such that the apparatus is self supporting with the barrel in the 45° position. The base block 42 of the general base structure 41 incorporates a level indicator 10, having a spirit-level type bubble in a tube. Markings on the tube enable the spirit level to be used to set the base plate 4 accurately horizontal, even when on a soft sandy surface 49, to ensure that the angle of projection of the weight is correctly set. Towards a lower end of the tank there is provided an inlet 332 which is connected to a pressure gauge 9 and an inlet valve 333. In this example the inlet valve 333 is a one-way non-return valve which is itself connected to a flexible hose 6. An end of the hose 6 is provided with a connector (not shown) for connecting to a high pressure scuba diving tank. Thus, compressed air or other gas from the high pressure tank can be supplied to the tank 33 through the non-return valve 333 to “charge” the apparatus. Then, the handle 351 of the manual valve 35 is rotated in the direction shown by the arrow A. Release of the compressed gas from the tank 33 into the bore 32 then projects the weight 1 out of the barrel 31. The flexible line 11 attached to the weight 1 is connected, via a connector 21, to a fishing line 2 and a fishing hook 22 and fishing bait 23. The flexible line 11 passes through an anchor device 5. The anchor device comprises a bore, and the flexible line 11 is threaded through this bore. Thus, the anchor device is slidable on the flexible line 11. The connector 21 constrains movement of the anchor 5 in one direction along the line, and the anchor may not slide off the other end of the flexible line 11 as it is constrained by the weight 1. The fishing line 2 is supplied from a reel 241 on a conventional fishing rod 24. Before projecting the weight 1 from the barrel 31, the reel is set so as to be freely rotatable such that the projected weight can pull out the fishing line 2. Thus, when the valve 35 is opened, the projected weight 1 exits the barrel at speed, and pulls the anchor 5, and hook and bait behind it. Using the pressure gauge 9, the tank 33 can be charged to different pressures to alter the distance that the weight 1 is thrown.

Typical lengths for the barrel are in the range 0.5-1 metre, and the weight 1 may have a length of between 5 and 10 centimetres. It will be appreciated, however, that other lengths for the barrel and weight may be used.

FIG. 2 shows one convenient form of weight. In this example, the weight 1 comprises a cylindrical copper tube 12, filled with lead 13. Attached to one end of the cylindrical structure is line attachment means in the form of an eye 11. Thus, the attachment means is provided at an end of the weight, and enables a fishing line to be tied to it.

After the weight 1 has been projected into the sea it falls to the seabed. The fishing line 2 may then be tightened using the rod 24, and the line is pulled through the bore in the anchor 5 until the weight 1 is generally against the anchor 5.

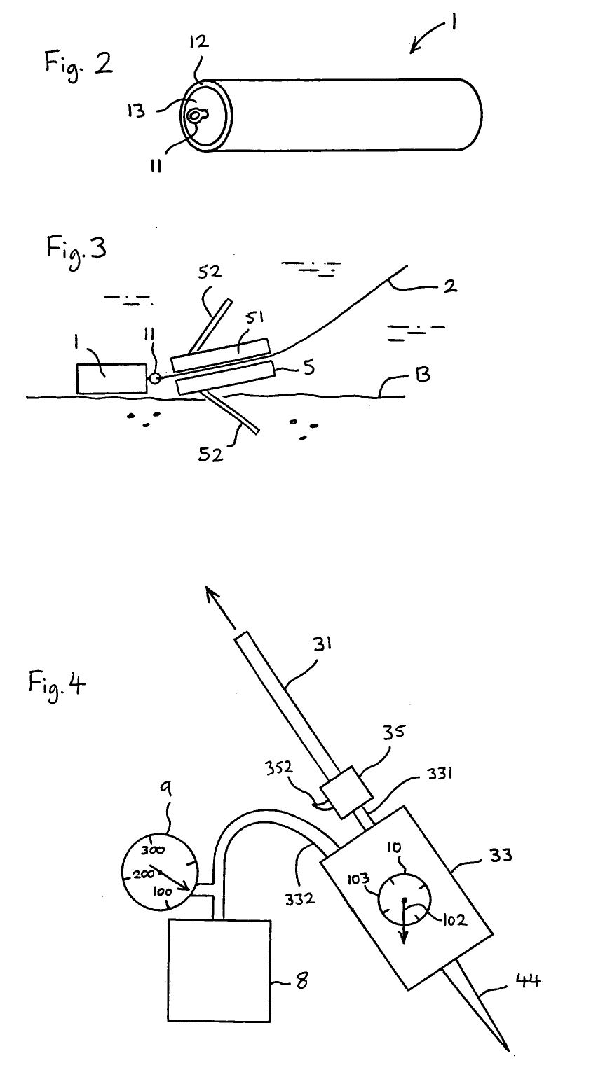

FIG. 3 shows the weight and anchor on the seabed. The anchor comprises a body 51 having a bore through which the line 2 passes. The anchor also comprises a plurality of prongs 52 which can embed themselves in the seabed B. Thus, the combination of weight 1 and anchor 5 holds the fishing line in place, and enables the line 2 to be pulled relatively taut.

Moving on to FIG. 4, this shows, in highly schematic form, a further embodiment. In this example, rather than a base plate and base block, the general base portion comprises a single spike 44 extending from a base of the tank 33 itself. This spike is for insertion in soft ground to hold the tank, and thus the barrel to which it is attached, at a desired inclination to the vertical. Rigidly attached to the tank 33 is the scale 103 of an inclination indicator 10. The indicator also includes a pointer 102 which is mounted on a pivot such that it may always adopt a position pointing vertically downwards. Thus, the combination of the pivoting pointer 102 and fixed scale 103 gives and indication of the inclination of the tank 33. At an upper end of the tank 33 there is provided an outlet 331, in line with a trigger valve 35 (having a manual trigger 352) and a barrel 31. Also at the upper end of the tank 33 there is provided an inlet hose 332 which is connected to a pressure gauge 9 and a pump 8. The pump 8 is operable to pressurise the tank 33, and the gauge 9 is calibrated in terms of the approximate distance the weight will be projected if the barrel is correctly arranged at 45° to the vertical.

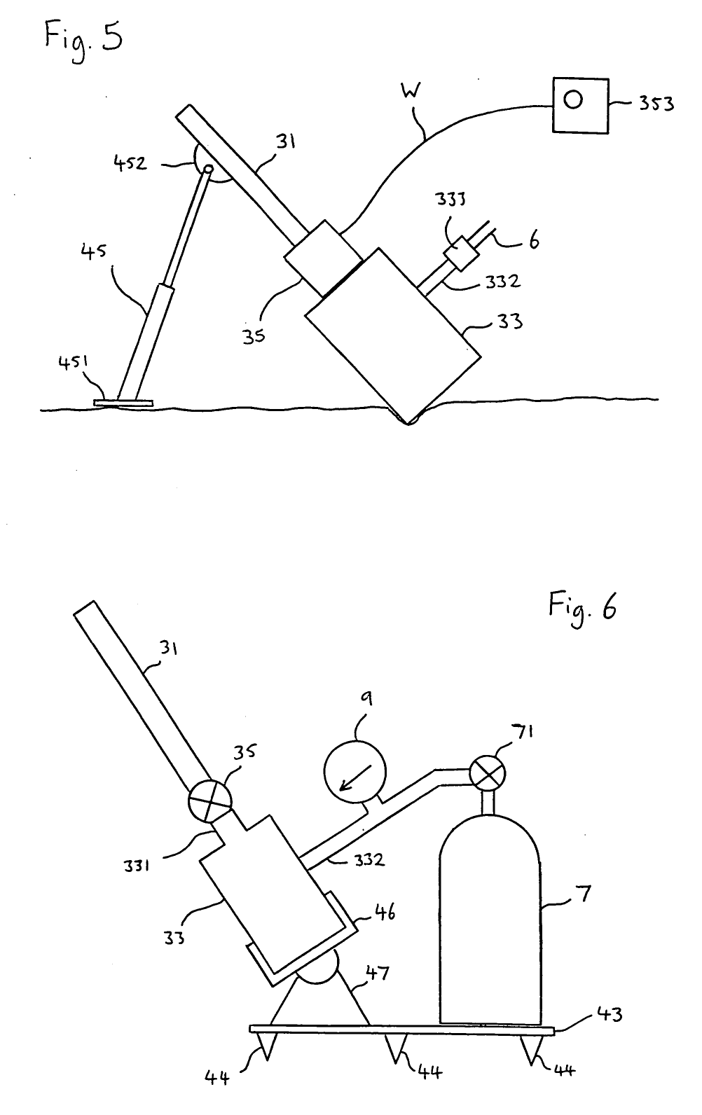

Moving on to FIG. 5, in this example the tank 33 is adapted to sit directly on soft ground, and the inclination of the barrel 31 is set using an adjustable strut assembly 45 having a foot 451 and being pivotally connected by suitable connection means 452 to the barrel 31. The valve 35 is an electrically operated valve, and opening of the valve is achieved by means of a wire link W to a remote control unit 353. For pressurising the tank 33 its inlet 332 is connected via a closable valve 333 to a supply hose 6.

In the embodiment of FIG. 6, the apparatus includes a base comprising a base plate 43, a plurality of spikes 44 extending from the base plate 43, and a hinged mount 46, 47 for supporting the tank 33. The base of the tank 33 is held within a portion of the hinged support 46 and its orientation relative to the base is therefore adjustable. The tank outlet 331 is rigidly coupled to a valve 35 and the barrel 31 such that the barrel inclination is adjustable with respect to the base. Also provided on the base is a diving tank 7, able to hold a supply of gas at pressures in the region of 2500-3500 psi. A valve 71 controls supply of gas from the diving tank 7 to the weight-projecting tank, and a pressure gauge 9 provides an indication of the charge pressure of the tank 33.

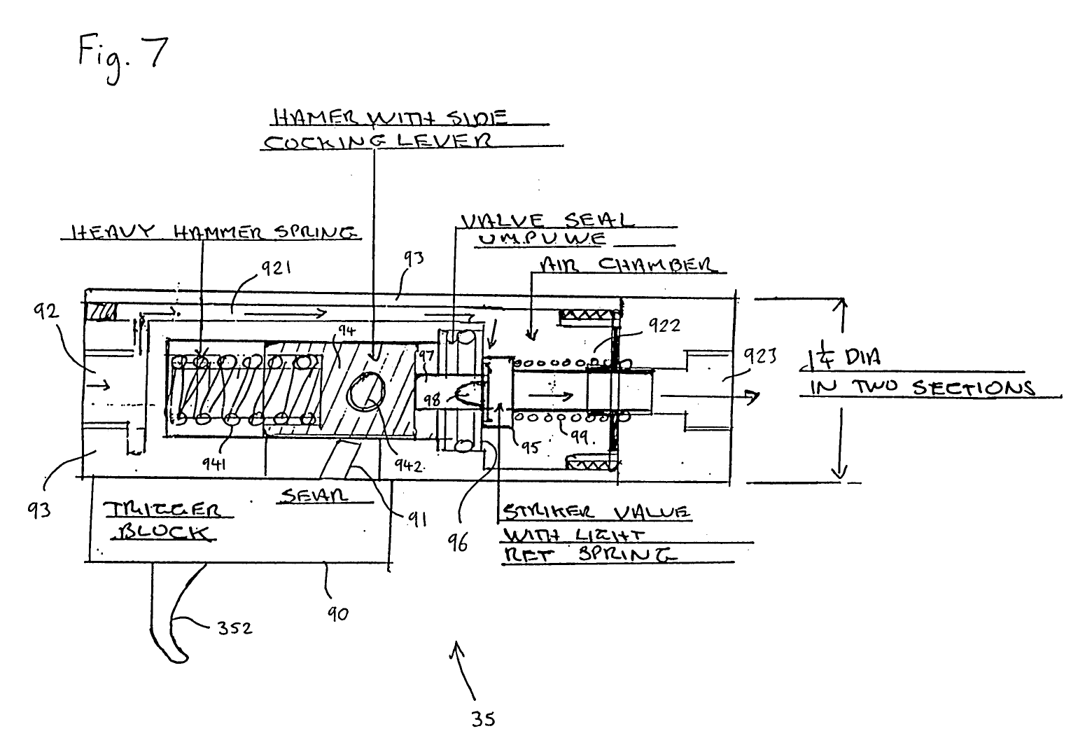

FIG. 7 shows a schematic cross section of a trigger valve suitable for use in embodiments of the present invention. This valve is able to hold off very high pressures (thus enabling the tanks 33 to be charged with gas at high pressure) and also provides rapid opening action to enable long projection distances of the weight to be achieved.

The valve comprises an aluminium body 93 having an inlet 92 for connection to the tank outlet. A gas passage 921 connects this inlet 92 to the air chamber 922. The presence of air at pressure in this chamber 922 urges the sealing member 95 of a striker valve into sealing engagement with a valve seat 96. A light return spring 99 biases the sealing member 95 towards this sealed position (i.e. closed position) and thus as air pressure in the tank is increased, the increased pressure simply urges the sealing member 95 into even tighter engagement with the valve seat. The sealing member 95 is rigidly connected to a valve tube 97 which has an opening 98 which, when the sealing member is against the valve seat, is inaccessible to the air at pressure. The valve also incorporates a hammer 94 with a side cocking lever 942. As the cocking lever is pulled towards the left in the figure, the hammer compresses a heavy hammer spring 941. When the hammer is pulled back far enough, a sear 91 catches the hammer and holds it in place, against the hammer spring. The valve includes a trigger block 90 to which the sear 91 and trigger 352 are mounted. When the trigger 352 is pulled, it moves the sear 91 to release the hammer which is thrown against an end of the valve tube 97. This in turn pushes the sealing member 95 away from the valve seat and breaks the seal. This permits air at pressure to enter the hole 98 in the valve tube and pass through the valve tube to the outlet 923 of the valve. In this example, the hammer is steel, and the striker valve is formed from tool steel. The striker valve incorporates the sealing member 95 and the valve tube 97.

It will be understood that the drawings illustrate examples of the apparatus of the invention only, and that the invention is not limited to the illustrated examples but is defined by the claims.

I claim:

1. Fishing apparatus comprising:
a weight comprising attachment means for attaching the weight to a fishing line; and
means for projecting the weight into a body of water, wherein the means for projecting comprises:
a barrel having a bore, the bore being adapted to receive the weight;
a tank adapted to hold a reservoir of compressed gas, such as air; and
valve means connected between the bore and tank, and operable to supply compressed gas from the tank to the bore to project the weight out of the barrel.

2. Apparatus according to claim 1 wherein the weight is elongate, having a longitudinal axis which is aligned substantially parallel to the longitudinal axis of the bore when the weight is received in the bore.

3. Apparatus according to claim 2, wherein the weight is generally cylindrical.

4. Apparatus according to claim 3 wherein the weight comprises a tube filled with dense material.

5. Apparatus according to claim 4 wherein the weight comprises a lead-filled copper tube.

6. Apparatus according to claim 1, wherein the weight is spherical.

7. Apparatus according to claim 1, wherein the weight comprises metallic core coated with a polymeric material.

8. Apparatus according to claim 1, wherein said attachment means is provided at one end of the weight.

9. Apparatus according to claim 1, wherein said attachment means comprises an eye, to which the fishing line may be tied.

10. Apparatus according to claim 1, wherein the attachment means comprises a flexible line, extending from the weight, to which the fishing line may be attached.

11. Apparatus according to claim 1, wherein said tank is elongate having an outlet at one end, said outlet being in line with the valve means and the barrel.

12. Apparatus according to claim 1, wherein the tank is generally cylindrical.

13. Apparatus according to claim 1, wherein the tank is mounted on a base plate.

14. Apparatus according to claim 13, wherein the tank and base plate are integral, the base plate closing a lower end of the tank.

15. Apparatus according to any one of claim 13, wherein the tank is mounted on the base plate such that when the base plate is horizontal, the tank is inclined at an angle of approximately 45° to the horizontal.

16. Apparatus according to claim 1, further comprising a line attached to the weight, and an anchor slidably mounted on the line but unable to slide past the weight.

17. Apparatus according to claim 1, wherein the tank comprises an inlet attached to an inlet valve, through which compressed gas may be supplied to the tank.

18. Apparatus according to claim 17, wherein the inlet valve is a non-return valve.

19. Apparatus according to claim 17, further comprising a hose connected to the inlet valve and adapted for connection to a compressed-gas refill tank.

20. Apparatus according to claim 1, further comprising a compressed-gas refill tank arranged to replenish said tank after operation of the valve means.

21. Apparatus according to claim 1, further comprising a pump operable to fill said tank with compressed gas.

22. Apparatus according to claim 1, wherein said tank is adapted to hold gas at pressures up to at least 2500 psi.

23. Apparatus according to claim 1, further comprising a pressure gauge arranged to provide an indication of the pressure of gas inside the tank.

24. Apparatus according to claim 23, wherein the pressure gauge is calibrated in terms of the distance the weight is projected for a particular inclination of the barrel and tank gas pressure.

25. Apparatus according to claim 1, comprising a base adapted to engage a ground surface and support the barrel in an inclined position.

26. Apparatus according to claim 25, wherein the base comprises a base plate adapted to rest on the ground.

27. Apparatus according to claim 26, where the base comprises at least one spike, extending from the base plate, for insertion into the ground.

28. Apparatus according to claim 25, wherein the base comprises at least one spike for insertion into the ground.

29. Apparatus according to claim 25, wherein the base is adapted to support the barrel such that its bore is inclined at 45° to the horizontal.

30. Apparatus according to claim 25, wherein the barrel is supported such that its orientation with respect to the base is fixed.

31. Apparatus according to claim 25, further comprising means for adjusting the orientation of the barrel with respect to the base to alter the inclination of the bore.

32. Apparatus according to claim 25, wherein the base comprises adjustment means for adjusting the inclination of the barrel bore to the horizontal.

33. Apparatus according to claim 1, further comprising means for indicating an inclination of the barrel bore to the horizontal.

34. Apparatus according to claim 33, wherein the means for indicating is arranged to indicate when the barrel bore is at 45° to the horizontal.

35. Apparatus according to claim 1, wherein the valve means comprises a manually operated valve.

36. Apparatus according to claim 1, wherein the valve means comprises a trigger valve including a sealing member held against a valve seat by gas pressure in the tank, a hammer triggerable to separate the sealing member from the valve seat to permit gas flow through the valve, and a trigger mechanism for triggering the hammer.

37. Apparatus according to claim 1, wherein the valve means comprises means for operating it remotely.
